(19) United States
(12) Patent Application Publication
(10) Pub. No.: US 2012/0141271 A1
(43) Pub. Date: Jun. 7, 2012

(54) ACTUATABLE SPOILER ASSEMBLIES FOR WIND TURBINE ROTOR BLADES

(75) Inventor: Chad Mark Southwick, Massena, NY (US)

(73) Assignee: GENERAL ELECTRIC COMPANY, Schenectady, NY (US)

(21) Appl. No.: 13/231,158

(22) Filed: Sep. 13, 2011

(51) Int. Cl. F03D 1/06; F03D 7/00

(52) U.S. Cl. 416/23; 416/1

(57) ABSTRACT

A rotor blade for a wind turbine is disclosed. The rotor blade may generally include a shell having a pressure side and a section side. The shell may define an outer surface along the pressure and suction sides over which an airflow travels. Additionally, the rotor blade may include a spoiler assembly having a deformable membrane disposed adjacent to the outer surface. The deformable membrane may be configured to be deformed relative to the outer surface such that at least a portion of the deformable membrane is movable between an un-actuated position to an actuated position. Additionally, the at least a portion of the deformable membrane may be configured to separate the airflow from the outer surface when in the actuated position.

### FIELD OF THE INVENTION

The present subject matter relates generally to wind turbines and, more particularly, to actuatable spoiler assemblies for wind turbine rotor blades.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The particular size of wind turbine rotor blades is a significant factor contributing to the overall efficiency of the wind turbine. Specifically, increases in the length or span of a rotor blade may generally lead to an overall increase in the energy production of a wind turbine. Accordingly, efforts to increase the size of rotor blades aid in the continuing growth of wind turbine technology and the adoption of wind energy as an alternative energy source. However, as rotor blade sizes increase, so do the loads transferred through the blades to other components of the wind turbine (e.g., the wind turbine hub and other components). For example, longer rotor blades result in higher loads due to the increased mass of the blades as well as the increased aerodynamic loads acting along the span of the blade. Such increased loads can be particularly problematic in high-speed wind conditions, as the loads transferred through the rotor blades may exceed the load-bearing capabilities of other wind turbine components.

Certain surface features, such as spoilers, are known that may be utilized to separate the flow of air from the outer surface of a rotor blade, thereby reducing the lift generated by the blade and reducing the loads acting on the blade. However, spoilers are typically designed to be permanently disposed along the outer surface of the rotor blade. As such, the amount of lift generated by the rotor blade is reduced regardless of the conditions in which the wind turbine is operating. Thus, there is a need for an actuatable spoiler that permits the loads acting on a rotor blade to be efficiently shed when desired (e.g., during high-speed wind conditions, such as wind gusts) without reducing the overall efficiency of the rotor blade during normal operating conditions. Moreover, there is a need for an actuatable spoiler configuration that permits a spoiler to be actuated without creating significant surface discontinuities (e.g., exposed holes or slots defined through the shell of the blade) along the surface of the rotor blade.

Accordingly, a rotor blade that includes one or more actuatable spoilers without creating substantial surface discontinuities would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a rotor blade for a wind turbine. The rotor blade may generally include a shell having a pressure side and a suction side. The shell may define an outer surface along the pressure and suction sides over which an airflow travels. Additionally, the rotor blade may include a spoiler assembly having a deformable membrane disposed adjacent to the outer surface. The deformable membrane may be configured to be deformed relative to the outer surface such that at least a portion of the deformable membrane is movable between an un-actuated position to an actuated position. Additionally, the at least a portion of the deformable membrane may be configured to separate the airflow from the outer surface when in the actuated position.

In another aspect, the present subject matter is directed to a rotor blade for a wind turbine. The rotor blade may generally include a shell having a pressure side and a suction side. The shell may define an outer surface along the pressure and suction sides over which an airflow travels. Additionally, the rotor blade may include a spoiler assembly having a deformable membrane disposed adjacent to the outer surface. The deformable membrane may be configured to be deformed relative to the outer surface such that at least a portion of the deformable membrane is movable between an un-actuated position to an actuated position. Additionally, the at least a portion of the deformable membrane may be configured to separate the airflow from the outer surface when in the actuated position. Moreover, the spoiler assembly may include means for moving the deformable membrane to the actuated position.

In a further aspect, the present subject matter discloses a method for actuating a spoiler assembly relative to an outer surface of a rotor blade of a wind turbine. The method may generally include applying a force to a deformable membrane disposed adjacent the outer surface in order to move at least a portion of the deformable membrane from an un-actuated position to an actuated position and removing the force from the deformable membrane in order to return the at least a portion of the deformable membrane to the actuated position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a perspective view of one embodiment of a rotor blade having a plurality of actuatable spoiler assemblies in accordance with aspects of the present subject matter;

FIG. 3 illustrates a cross-sectional view of the rotor blade shown in FIG. 2 taken along line 3-3, particularly illustrating the various components of one of the actuatable spoiler assemblies;

FIG. 4 illustrates a partial, cross-sectional view of the rotor blade shown in FIG. 3, particularly illustrating a deformable membrane of the actuatable spoiler assembly in an actuated position;

FIG. 5 illustrates another partial, cross-sectional view of the rotor blade shown in FIG. 3, particularly illustrating the deformable membrane of the actuatable spoiler assembly in an un-actuated position;

FIG. 6 illustrates a partial, cross-sectional view of the rotor blade shown in FIG. 2 having another embodiment of an actuatable spoiler assembly installed therein in accordance with aspects of the present subject matter, particularly illustrating a deformable membrane of the actuatable spoiler assembly in an actuated position;

FIG. 7 illustrates another partial, cross-sectional view of the rotor blade shown in FIG. 6, particularly illustrating the deformable membrane of the actuatable spoiler assembly in an un-actuated position;

FIG. 8 illustrates a partial, cross-sectional view of the rotor blade shown in FIG. 2 having a further embodiment of an actuatable spoiler assembly installed therein in accordance with aspects of the present subject matter, particularly illustrating a deformable membrane of the actuatable spoiler assembly in an actuated position; and,

FIG. 9 illustrates another partial, cross-sectional view of the rotor blade shown in FIG. 8, particularly illustrating the deformable membrane of the actuatable spoiler assembly in an un-actuated position.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a rotor blade including an actuatable spoiler assembly. In particular, an actuatable spoiler assembly is disclosed that includes a deformable membrane configured to be deformed and/or moved between an un-actuated position, wherein the deformable membrane is generally aligned with an outer surface of the rotor blade, and an actuated position, wherein the deformable membrane forms a spoiler-like member extending outwardly from the outer surface. As such, the deformable membrane may be utilized to effectively shed loads acting on the rotor blade when it is in the actuated position and may be in general alignment with the outer surface of the blade when in the un-actuated position so as to not affect the performance of the blade.

Additionally, the use of the deformable membrane may provide an actuatable spoiler without creating substantial surface discontinuities in the outer surface of the rotor blade. Specifically, the deformable membrane may be installed over and may cover any holes or slots that have been formed through the outer surface in order to facilitate actuation of the membrane. As such, the deformable membrane may provide an environmental barrier for the rotor blade. For instance, the deformable membrane may prevent water, dirt, snow, ice and/or the like from entering the internal cavity of the rotor blade through the holes or slots defined in the blade.

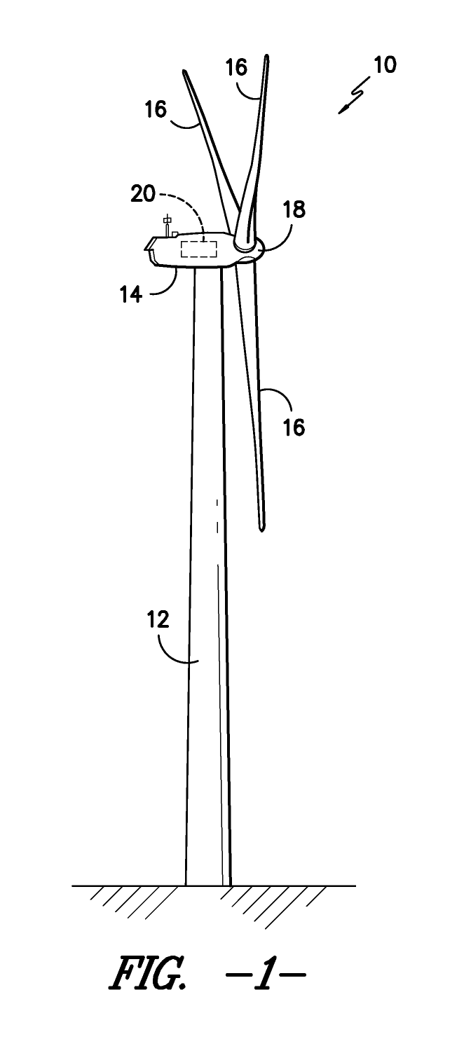

Referring now to the drawings, FIG. 1 illustrates perspective view of one embodiment of a wind turbine 10. The wind turbine 10 includes a tower 12 with a nacelle 14 mounted thereon. A plurality of rotor blades 16 are mounted to a rotor hub 18, which is, in turn, connected to a main flange that turns a main rotor shaft. The wind turbine power generation and control components (e.g., a turbine controller 20) may be housed within the nacelle 14. It should be appreciated that the view of FIG. 1 is provided for illustrative purposes only to place the present subject matter in an exemplary field of use. Thus, one of ordinary skill in the art should readily appreciate that the present subject matter need not be limited to any particular type of wind turbine configuration.

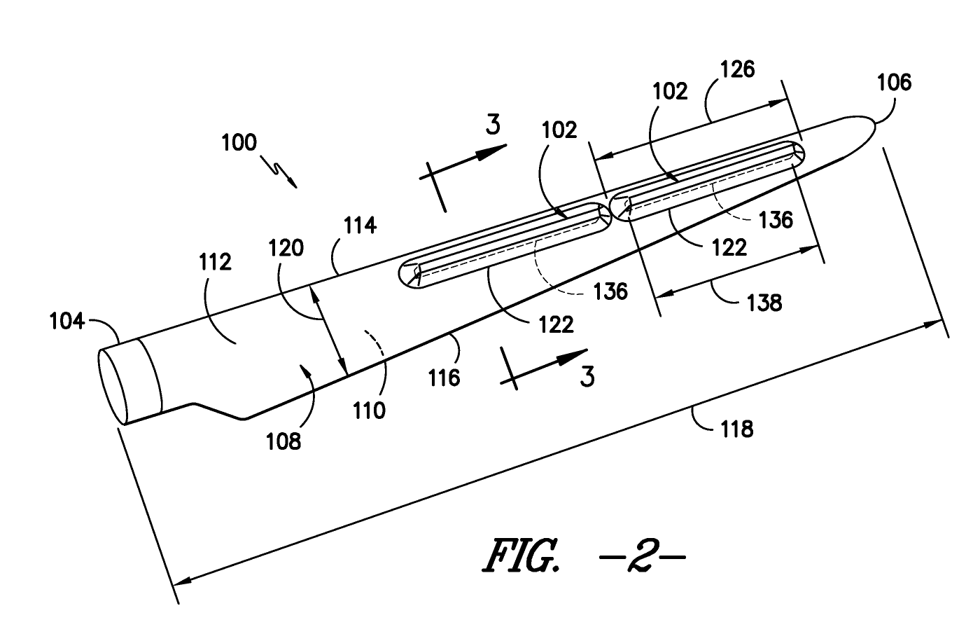

Referring now to FIG. 2, a perspective view of one embodiment of a rotor blade 100 having one or more actuatable spoiler assemblies 102 is illustrated in accordance with aspects of the present subject matter. As shown, the disclosed rotor blade 100 may generally include a blade root 104 configured for mounting the rotor blade 100 to the hub 18 of the wind turbine 10 (FIG. 1) and a blade tip 106 disposed opposite the blade root 104. A shell 108 of the rotor blade 100 may generally be configured to extend between the blade root 104 and the blade tip 106 and may serve as the outer casing/skin of the blade 100. In several embodiments, the shell 108 may define a substantially aerodynamic profile, such as by defining a symmetrical or cambered airfoil-shaped cross-section. As such, the shell 108 may define a pressure side 110 and a suction side 112 extending between a leading edge 114 and a trailing edge 116. Further, the rotor blade 100 may have a span 118 defining the total length between the blade root 104 and the blade tip 106 and a chord 120 defining the total length between the leading edge 114 and the trialing edge 116. As is generally understood, the chord 120 may vary in length with respect to the span 118 as the rotor blade 100 extends from the blade root 104 to the blade tip 106.

In several embodiments, the shell 108 of the rotor blade 100 may be formed as a single, unitary component. Alternatively, the shell 108 may be formed from a plurality of shell components. For example, the shell 108 may be manufactured from a first shell half generally defining the pressure side 110 of the rotor blade 100 and a second shell half generally defining the suction side 112 of the rotor blade 100, with the shell halves being secured to one another at the leading and trailing edges 114, 116 of the blade 100. Additionally, the shell 108 may generally be formed from any suitable material. For instance, in one embodiment, the shell 108 may be formed entirely from a laminate composite material, such as a carbon fiber reinforced laminate composite or a glass fiber reinforced laminate composite. Alternatively, one or more portions of the shell 108 may be configured as a layered construction and may include a core material, formed from a lightweight material such as wood (e.g., balsa), foam (e.g., extruded polystyrene foam) or a combination of such materials, disposed between layers of laminate composite material.

It should be appreciated that the rotor blade 100 may also include one or more internal structural components. For example, in several embodiments, the rotor blade 100 may include one or more shear webs (not shown) extending between corresponding spar caps (not shown). However, in other embodiments, the rotor blade 100 of the present disclosure may have any other suitable internal configuration.

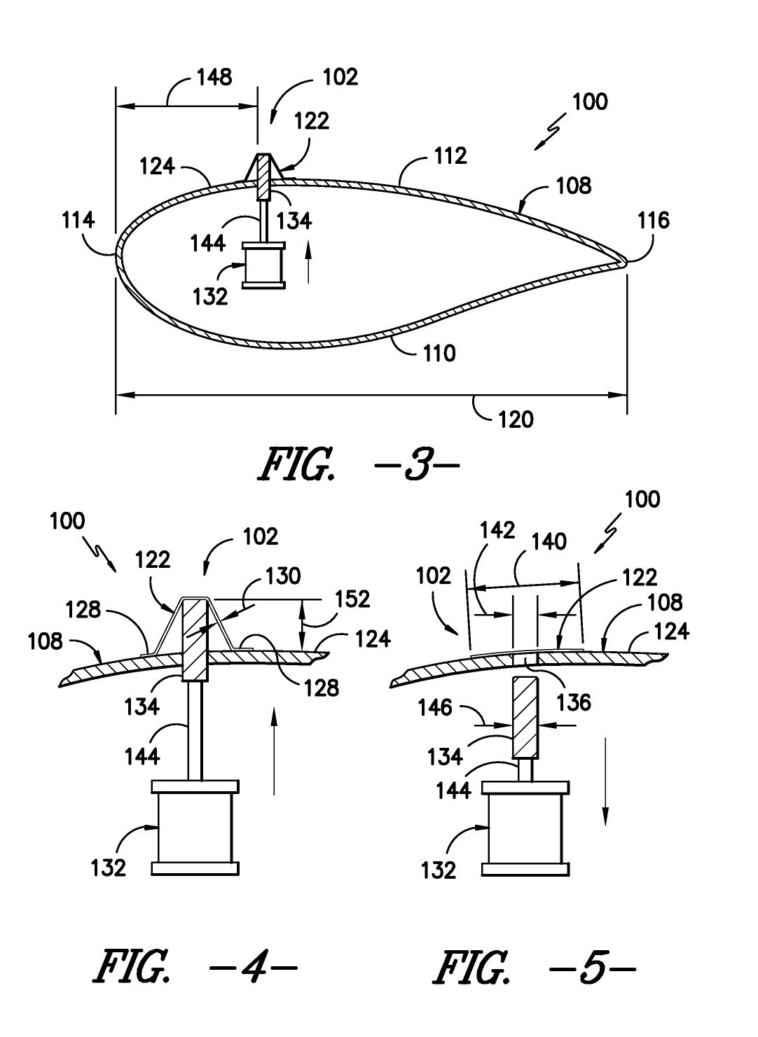

Additionally, as indicated above, the rotor blade 100 may also include one or more actuatable spoiler assemblies 102 spaced apart along the blade 100. As will be described in greater detail below, each spoiler assembly 102 may generally include a deformable membrane 122 configured to be deformed relative to an outer surface 124 (FIGS. 3-5) of the shell 108, such as by being configured to be moved from an un-actuated position (FIG. 5) to an actuated position (FIGS. 3 and 4). As such, when the deformable membrane 122 is moved to the actuated position, a spoiler-like member may be formed along the outer surface 124 of the rotor blade 100 that permits the airflow flowing past the blade 100 to be separated from the outer surface 124.

It should be appreciated that the rotor blade 100 may generally include any suitable number of spoiler assemblies 102. For example, as shown in FIG. 2, the rotor blade 100 includes two spoiler assemblies 102 spaced apart along the blade 100. However, in alternative embodiments, the rotor blade 100 may only include one spoiler assembly 102 or the rotor blade 100 may include greater than two spoiler assemblies 102, such as three spoiler assemblies 102, four spoiler assemblies 102 or more than four spoiler assemblies 102. Additionally, each spoiler assembly 102 may generally be disposed at any suitable location on the rotor blade 100. For instance, as shown in FIG. 2, each spoiler assembly 102 is positioned on the suction side 112 of the rotor blade 100. In alternative embodiments, each spoiler assembly 102 may be positioned on the pressure side 110 of the rotor blade 100 or spoiler assemblies 102 may be positioned on both sides 110, 112 of the rotor blade 100. Similarly, the spoiler assemblies 102 may generally be disposed at any suitable location along the span 118 of the rotor blade 100, such as from generally adjacent the blade root 104 to generally adjacent the blade tip 106.

Moreover, in embodiments in which the rotor blade 100 includes more than one spoiler assembly 102, the spoiler assemblies 102 may be spaced apart from one another along the rotor blade 100 in any direction. For instance, as shown in FIG. 2, the spoiler assemblies 102 may be spaced apart from one another in the spanwise direction. In other embodiments, the spoilers 102 may be spaced apart from one another in the chordwise direction or in both the spanwise and chordwise directions. One of ordinary skill in the art should appreciate that the “chordwise direction” refers to a direction extending parallel to the chord 120 of the rotor blade 100 and the “spanwise direction” refers to the a direction extending parallel to the span 118 of the rotor blade 100.

Additionally, each spoiler assembly 102 may generally define any suitable length 126 along the rotor blade 100, which, in several embodiments, may generally correspond to the length 126 of the deformable membrane 122. For instance, in one embodiment, the spoiler assemblies 102 may have a length 126 generally equal to the span 118 of the rotor blade 100 such that each spoiler assembly 102 extends from generally adjacent the blade root 104 to generally adjacent the blade tip 106. In other embodiments, the spoiler assemblies 102 may define shorter lengths 126. For example, in a particular embodiment of the present subject matter, each spoiler assembly 102 may define a length that is less than 5 meters (m), such as less than 3 m or less than 2 m and all other subranges therebetween.

Referring now to FIGS. 3-5, there are illustrated cross-sectional views of the rotor blade 100 shown in FIG. 2. In particular, FIG. 3 illustrates a cross-sectional view of the rotor blade 100 shown in FIG. 2 taken along line 3-3, particularly illustrating the various components of one of the spoiler assemblies 102. FIG. 4 illustrates a partial, cross-sectional view of the rotor blade 100 shown in FIG. 3, particularly illustrating the deformable membrane 122 of the spoiler assembly 102 in an actuated position. Additionally, FIG. 5 illustrates another partial, cross-sectional view of the rotor blade 100 shown in FIG. 3, particularly illustrating the deformable membrane 122 of the spoiler assembly 102 in an un-actuated position

In general, as indicated above, the spoiler assembly 102 may include a deformable membrane 122 disposed adjacent to the outer surface 124 of the shell 108. In addition, the spoiler assembly 102 may include any suitable means for moving the deformable membrane 122 from an un-actuated position (FIG. 5), wherein the deformable membrane 122 is generally aligned with the outer surface 124, to an actuated position (FIGS. 3 and 4), wherein at least a portion of the deformable membrane 122 is positioned above the outer surface 124 so as create a spoiler-like member along the outer surface 124. As such, at times of increased loading on the rotor blade 100 (e.g., during operation in high-speed wind conditions), the deformable membrane 122 may be moved to the actuated position (e.g., by deforming at least a portion of the deformable membrane 122) in order to separate the air flowing over the rotor blade 100 from the outer surface 124, thereby reducing the lift generated by the blade 100 and decreasing the loads transferred through the blade 100 to other components of the wind turbine 10 (e.g., the wind turbine hub 18 (FIG. 1)). However, when blade loading is not an issue (e.g., in low-speed wind conditions), the deformable membrane 122 may be returned to the un-actuated position so as to not affect the performance and/or efficiency of the rotor blade 100.

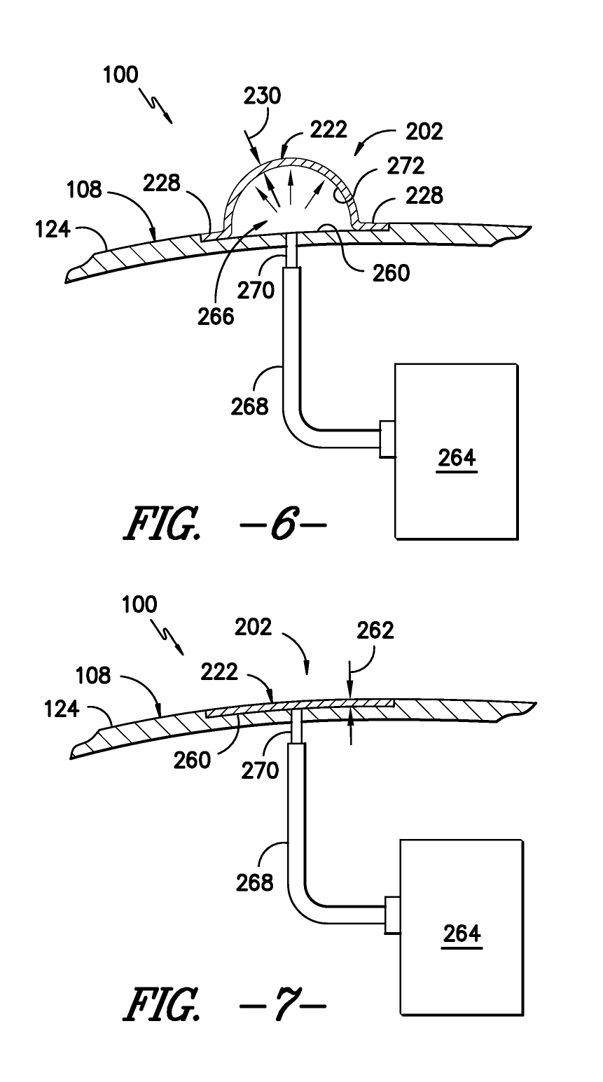

The deformable membrane 122 of the spoiler assembly 102 may generally be configured to be attached to the rotor blade 100 at any suitable location generally adjacent to the outer surface 124 of the shell 108. For example, in several embodiments, the deformable membrane 122 may be attached directly to the outer surface 124. Specifically, as shown in FIG. 4, a portion of each side 128 of the deformable membrane 122 may be attached to the outer surface 124, such as by bonding a portion of the sides 128 to the outer surface 124 using a suitable adhesive or by using any other suitable attachment means and/or method. However, in alternative embodiments, the deformable membrane 122 may be attached to the shell 108 at any other suitable location adjacent to the outer surface 124. For example, as will be described below with reference to FIGS. 6 and 7, the deformable membrane 122 may be attached to a recessed surface 260 defined in the shell 108 below the outer surface 124.

Additionally, in several embodiments, the deformable membrane 122 may have a relatively small thickness 130 (FIG. 4). For example, in several embodiments, the thickness 130 of the deformable membrane 122 may be less than about 0.250 inches (about 6.35 millimeters), such as less than about 0.100 inches (about 2.54 millimeters), or less than about 0.010 inches (about 0.254 millimeters) and all other subranges therebetween. By configuring the deformable membrane 122 to have a relatively small thickness 130, it should be appreciated that the deformable membrane 122 may be attached directly to the outer surface 124 of the shell 108 without creating a significant surface discontinuity along the outer surface 124 For example, as shown in FIG. 5, when the deformable membrane 122 is in the un-actuated position, it may be generally aligned with the outer surface 124, thereby defining a substantially continuous aerodynamic surface between the deformable membrane 122 and the outer surface 124. However, in alternative embodiments, the thickness 130 of the deformable membrane 122 may be greater than about 0.250 inches. In such embodiments, it may be desirable, but not necessary, to recess at least a portion of the deformable membrane 122 below the outer surface 124 of shell 108 (e.g., by attaching the deformable membrane 122 to the recessed surface 260 described below with reference to FIGS. 6 and 7) in order to provide a substantially continuous aerodynamic surface between the outer surface 124 and the deformable membrane 122.

Moreover, the deformable membrane 122 may be formed from any suitable deformable material. For example, in several embodiments, the deformable membrane 122 may be formed from an elastic material that allows the membrane 122 to be both deformed (e.g., stretched, bent and/or bowed) upon application of a force to the membrane 122 and returned to a steady state when such force is removed. For example, in several embodiments, the deformable membrane 122 may be formed from an elastic polymer material or a rubber material. In other embodiments, the deformable membrane 122 may be formed from any other suitable material, such as plastics, cloths/fabrics, synthetics and/or thin metals.

Due to the deformable and/or elastic nature of the deformable membrane 122, the membrane 122 may be configured to be deformed and/or moved relative to the outer surface 124 of the shell 108 from an un-actuated position (FIG. 5) to an actuated position (FIGS. 3 and 4). Thus, as indicated above, to facilitate such deformation and/or movement, the spoiler assembly 102 may include any suitable means for deforming and/or moving the deformable membrane 122 to the actuated position. For example, in several embodiments, the spoiler assembly 102 may include an actuator 132 configured to apply an outward force against the deformable membrane 122. Specifically, as shown in FIGS. 3 and 4, the actuator 132 may be disposed within the rotor blade 100 and may be configured to actuate an actuating ram 134 through a slot 136 (FIG. 5) defined in the shell 108 in order to force the deformable membrane 122 outwardly into the actuated position.

In such an embodiment, the deformable membrane 122 may generally be configured to be disposed over the slot 136 defined in the shell 108. For example, as shown in FIG. 5 the deformable membrane 122 may be secured to the outer surface 124 of the shell 108 so as to extend over the slot 136, thereby permitting the actuating ram 134 to be engaged against a portion of the deformable membrane 122 when the ram 134 is actuated through the slot 136. Additionally, in several embodiments, the deformable membrane 122 may be dimensioned so as completely cover the slot 136, thereby preventing the slot 136 from creating a surface discontinuity along the outer surface 124 of the shell 108. For instance, as shown in FIG. 2, the length 126 of the deformable membrane 122 may be equal to greater than an overall length 138 of the slot 136. Similarly, as shown in FIG. 5, a width 140 of the deformable membrane 122 may be equal to or greater than a width 142 of the slot 136.

It should also be appreciated that the actuator 132 may generally comprise any suitable actuating device known in the art. For example, in several embodiments, the actuator 132 may comprise a linear displacement device configured to linearly actuate the actuating ram 134 from within the rotor blade 100. Thus, as shown in the illustrated embodiment, the actuator 132 may comprise a hydraulic, pneumatic or any other suitable type of cylinder. However, in alternative embodiments, the actuator 132 may comprise any other suitable actuating device, such as a cam actuated device, an electro-magnetic solenoid or motor, other electro-magnetically actuated devices and/or any other suitable linear displacement device.

Moreover, it should be appreciated the actuating ram 134 may comprise a component of the actuator 132 (e.g., the actuated component of the actuator 132) or the actuating ram 134 may comprise a separate component configured to be separately attached to the actuator 132. For example, as shown in the illustrated embodiment, the actuating ram 134 may be secured to the end of a piston rod 144 of the actuator 132. Additionally, the actuating ram 134 may generally have any suitable dimensions and/or may define any suitable cross-sectional shape (e.g., a rectangular, triangular or any other suitable cross-sectional shape). For instance, in several embodiments, the actuating ram 134 may have dimensions corresponding to the dimensions of the slot 136 (e.g., by having a width 146 and/or a length (not shown) generally corresponding to the width 142 and/or length 138 of the slot 136. As such, in embodiments in which the length 126 of the deformable membrane 122 is generally equal to the length 138 of the slot 136, the actuating ram 134 may be configured to apply a force against the deformable membrane 122 along its entire length. Moreover, by adjusting the width 146 and/or shape of the actuating ram 134, the shape of the spoiler-like member formed by the deformable membrane 122 when it is moved to the actuated position may be varied. For example, by increasing the width 146 of the actuating ram 134 shown in the illustrated embodiment, a more rectangular shaped spoiler-like member may be formed by the deformable membrane 122. Similarly, by decreasing the width 146 of the actuating ram 134 shown in the illustrated embodiment, a more triangular shaped spoiler-like member may be formed by the deformable membrane 122.

It should also be appreciated that any suitable number of actuators 132 may be utilized to actuate the actuating ram 134. For instance, in one embodiment, two or more actuators 132 may be disposed within the rotor blade 100 at differing locations along the length of the actuating ram 134. However, in another embodiment, a single actuator 132 may be utilized to actuate the actuating ram 134.

Moreover, as particularly shown in FIG. 5, upon removal of the force applied by the actuator 132 (e.g., by moving the actuating ram 134 to the recessed position shown in FIG. 5), the deformable membrane 122 may be returned to the un-actuated position. In several embodiments, the deformable membrane 122 may be returned to the un-actuated position due primarily to the nature of the material used to form the deformable membrane 122. For instance, in embodiments in which the deformable membrane 122 is formed from an elastic material, the deformable membrane 122 may automatically return to the un-actuated position when the force applied by the actuator 134 is removed. As an alternative to the use of elastic materials or in addition thereto, the deformable membrane 122 may be returned to the un-actuated position by applying an inward force to the membrane 122. For example, in one embodiment, the deformable membrane 122 may be coupled to the actuating ram 134 such that, as the actuating ram 134 is moved into its recessed position, the deformable membrane 122 is pulled downward into the un-actuated position. In another embodiment, a suitable biasing mechanism (e.g., a spring) may be coupled to the deformable membrane 122 in order to bias the membrane 122 into the un-actuated position.

Referring still to FIGS. 3-5, it should be appreciated that the spoiler assembly 102 may generally be positioned at any suitable location along the chord 120 of the rotor blade 100, such as by being spaced apart from the leading edge 114 of the shell 108 any suitable distance 148. For example, as shown in FIG. 3, in one embodiment, a point on the spoiler-like member formed by the deformable membrane 122 may be positioned along the outer surface 124 of the shell 108 a distance 148 from the leading edge 114 (measured in the chordwise direction) ranging from about 5% to about 30% of the corresponding chord 120 defined at the specific spanwise location of the spoiler assembly 102, such as from about 10% to about 20% of the corresponding chord 120 or from about 15% to about 25% and all other subranges therebetween. However, in other embodiments, it should be appreciated that the distance 148 may be less than 5% of the length of the corresponding chord 120 or may be greater than 30% of the length of the corresponding chord 120.

Additionally, the spoiler-like member formed by deformable membrane 122 may generally be configured to define any suitable height 152 (FIG. 4) above the outer surface 124 of the shell 108. For example, in several embodiments, the height 152 may range from about 0.05% to about 1.5% of the corresponding chord 120 defined at the specific spanwise location of the spoiler assembly 102, such as from about 0.1% to about 0.3% of the corresponding chord 120 or from about 0.5% to about 1.2% of the corresponding chord 120 and all other subranges therebetween. Thus, in such embodiments, the ranges of the heights 152 may generally increase as the spoiler assembly 102 is positioned closer to the blade root 104 and may generally decrease as the spoiler assembly 102 is positioned closer to the blade tip 106. In other embodiments, it should be appreciated that the height 152 may be less than 0.05% of the corresponding chord 120 defined at the specific spanwise location of the spoiler 102 or may be greater than 1.5% of the corresponding chord 120.

It should also be appreciated that the height 152 to which the deformable membrane 122 is deformed and/or moved need not be fixed. For example, the actuator 132 may be configured to actuate the deformable membrane 122 to varying heights 152 depending on the loads acting on the rotor blade 100. In particular, depending on the magnitude of the blade loading (e.g., the amount of the lift being generated by the rotor blade 100), the actuator 132 may configured to actuate the deformable membrane 122 to a specific height 152 designed to sufficiently separate the flow of air from the outer surface 124 of the shell 108 so as to achieve the desired load reduction.

Referring now to FIGS. 6 and 7, there is illustrated another embodiment of an actuatable spoiler assembly 202 in accordance with aspects of the present subject matter. Specifically, FIG. 6 illustrates a partial, cross-sectional view of the rotor blade 100 described above with reference to FIGS. 2-5 having the spoiler assembly 202 installed therein, particularly illustrating a deformable membrane 222 of the spoiler assembly 202 in an actuated position. Additionally, FIG. 7 illustrates another partial, cross-sectional view of the rotor blade 100 shown in FIG. 6, particularly illustrating the deformable membrane 222 of the spoiler assembly 202 in an un-actuated position.

In general, the spoiler assembly 202 may be configured the same as or similar to the spoiler assembly 102 described above with reference to FIGS. 3-5 and, thus, may include many or all of the same components. For example, the spoiler assembly 202 may include a deformable membrane 222 configured to be deformed and/or moved between an un-actuated position (FIG. 7), wherein the deformable membrane 222 is generally aligned with the outer surface 124 of the shell 108 and an actuated position (FIG. 6), wherein at least a portion of the deformable membrane 222 is positioned above the outer surface 124 of the shell 108 so as define a spoiler-like member along the outer surface 124. Additionally, the deformable membrane 222 may be configured to be secured to the rotor blade 100 at a location adjacent to the outer surface 124 of the shell 108. However, unlike the embodiment described above, the deformable membrane 22 may be attached directly to a recessed surface 260 defined in the shell 108 below the outer surface 124. Specifically, as shown in FIG. 6, each side 228 of the deformable membrane 222 may be attached to the recessed surface 260 so that at least a portion of the deformable membrane 222 is recessed below the outer surface 124. As such, a substantially continuous aerodynamic surface may be defined between the outer surface 124 and the deformable membrane 222.

It should be appreciated that, in several embodiments, a height 262 (FIG. 7) defined between the recessed surface 260 and the outer surface 124 may generally correspond to a thickness 230 (FIG. 6) of the deformable membrane 222. However, in alternative embodiments, the height 262 may be less than the thickness 230 of the deformable membrane 222 or greater than the thickness 230 of the deformable membrane 222.

It should also be appreciated that, in alternative embodiments, the deformable membrane 222 need not be attached to the recessed surface 260. For example, similar to the embodiment described above, the deformable membrane 22 may be attached directly to the outer surface 124 of the shell 108.

Additionally, the spoiler assembly 202 may include a suitable means for deforming and/or moving the deformable membrane 222 from the un-actuated position to the actuated position. However, unlike the actuator 132 described above, the deformable membrane 222 may be deformed and/or moved to the actuated position by using a pressurized fluid source 264 to inflate at least a portion of the membrane 222. For example, as shown in the illustrated embodiment, a cavity 266 defined at least partially by the deformable membrane 222 may be configured to be filled with pressurized fluid supplied from the pressurized fluid source 264 through a suitable fluid coupling. Specifically, as shown in FIGS. 6 and 7, the pressurized fluid source 264 may be in flow communication with the cavity 266 through a tube or hose 268 extending from the pressurize fluid source 264 to a nozzle 270 extending through the shell 108. As such, pressurized fluid may be directed from the pressurized fluid source 264 into the cavity 266 in order to deform and/or move the deformable membrane 22 into the actuated position, thereby creating a spoiler-like member along the outer surface 124 of the shell 108. Similarly, by evacuating the pressurized fluid from the cavity 266, the deformable membrane 222 may be returned to the un-actuated position.

It should be appreciated that the pressurized fluid source 264 may generally comprise any suitable device capable of supplying a pressurized fluid to the cavity 266. For example, in several embodiments, the pressurized fluid source 264 may comprise an air compressor or any other suitable fluid pump. In another embodiment, the pressurized fluid source 264 may comprise a pressurized vessel (e.g., an air tank) having a fixed volume of pressurized fluid contained therein. Additionally, any suitable means may be used to control when and what amount of pressurized fluid is supplied to the cavity 266 by the pressurized fluid source 264. For instance, a valve (not shown) may be disposed between the pressurized fluid source 264 and the cavity 264 to turn the supply of pressurized fluid on/off as well as to control the amount of pressurized fluid supplied to the cavity 266.

Moreover, it should be appreciated that the pressurized fluid source 264 may be disposed at any suitable location relative to the deformable membrane 222. For example, as shown in the illustrated embodiment, the pressurized fluid source 264 is disposed within the rotor blade 100. In other embodiments, the pressurized fluid source 264 may be disposed at any other location within the wind turbine 10, such as within the hub 18, the nacelle 14 and/or the tower 12 of the wind turbine 10 (FIG. 1). In even further embodiments, the pressurized fluid source 266 may be disposed exterior of the wind turbine 10.

Further, in several embodiments of the present subject matter, the cavity 166 within which the pressurize fluid is supplied may be defined partially the deformable membrane 222 and partially by the shell 108 of the rotor blade 100. For example, as shown in FIG. 6, the cavity 266 may be defined between an inner surface 272 of the deformable membrane 222 and the recessed surface 260 of the shell 108. In such an embodiment, it should be appreciated that the sides 228 of the deformable membrane 228 may be sealed against the recessed surface 260 so as to create a fluid tight seal at the interface defined between the deformable membrane 222 and the shell 108, thereby preventing fluid leakage from the cavity 266. Similarly, the nozzle 270 or other fluid coupling extending through the shell 108 may be sealed to the shell 108 to prevent fluid leakage from the cavity 266. In another embodiment, the cavity 266 may be defined entirely by the deformable membrane 222. For example, the deformable membrane 222 may be configured as an inflatable member (e.g., a balloon-like member) defining a closed volume configured to be in flow communication with the pressurized fluid source 264 through a suitable fluid coupling.

Additionally, in several embodiments, an internal blade cavity in flow communication with the cavity 266 (e.g., an internal cavity defined within the rotor blade 100 at or adjacent to the deformable membrane 222) may be pressurized to provide the actuating force necessary to deform the membrane 222 into the actuated position. For example, the pressurized fluid source 264 may be configured to supply pressurized fluid to the internal blade cavity, which may then be utilized to pressurize the cavity 266 defined below the deformable membrane 222. In such an embodiment, a suitable locking mechanism (e.g., an actuatable mechanical lock or adjustable pressure seal) may be utilized to constrain or otherwise maintain the deformable membrane 222 in the un-actuated position until it is desired that the membrane 222 be deformed into the actuated position.

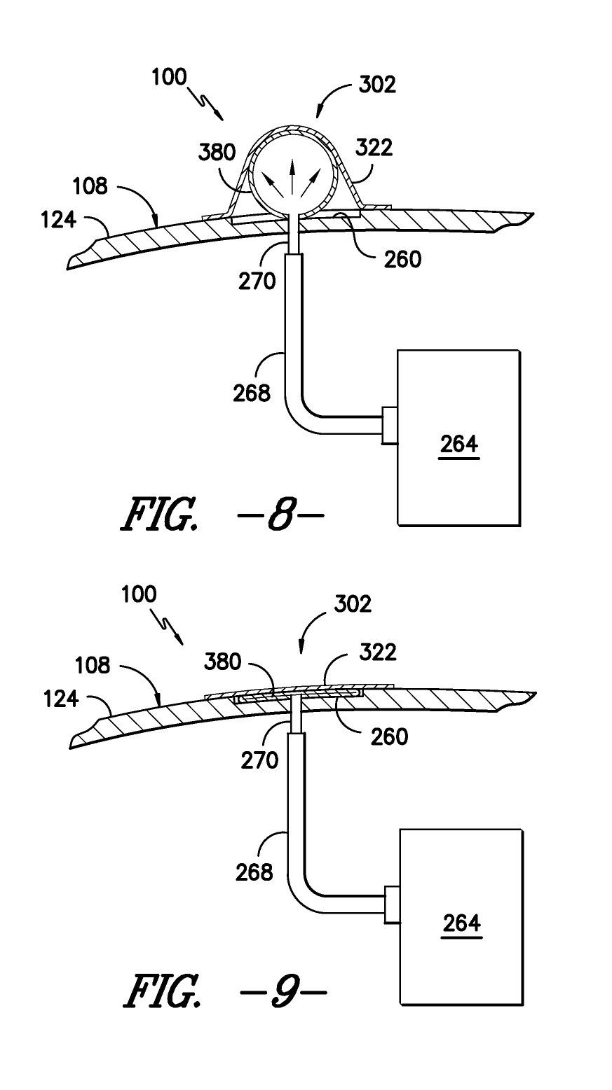

Referring now to FIGS. 8 and 9, there is illustrated another embodiment of an actuatable spoiler assembly 302 in accordance with aspects of the present subject matter. Specifically, FIG. 8 illustrates a partial, cross-sectional view of the rotor blade 100 described above with reference to FIGS. 2-5 having the spoiler assembly 302 installed therein, particularly illustrating a deformable membrane 322 of the spoiler assembly 302 in an actuated position. Additionally, FIG. 9 illustrates another partial, cross-sectional view of the rotor blade 100 shown in FIG. 8, particularly illustrating the deformable membrane 322 of the spoiler assembly 302 in an un-actuated position.

In general, the spoiler assembly 302 may be configured the same as or similar to the spoiler assemblies 102, 202 described above with reference to FIGS. 3-7 and, thus, may include many or all of the same components. For example, the spoiler assembly 302 may include a deformable membrane 322 configured to be secured to the rotor blade 100 at a location adjacent to the outer surface 124 of the shell 108. Additionally, the deformable membrane 322 may be configured to be deformed and/or moved from an un-actuated position (FIG. 9), wherein the deformable membrane 322 is generally aligned with the outer surface 124 of the shell 108 to an actuated position (FIG. 8), wherein at least a portion of the deformable membrane 322 is positioned above the outer surface 124 of the shell 108 so as define a spoiler-like member along the outer surface 124.

In addition, the spoiler assembly 302 may include a pressurized fluid source 264. However, unlike the embodiment described above, the pressurized fluid source 264 may be in flow communication with a separate inflatable member 380 disposed between the deformable membrane 322 and the shell 108. Specifically, as shown in the illustrated embodiment, the inflatable member 380 may be disposed between the deformable membrane 322 and a recessed surface 260 defined in the shell 108 and may be in flow communication with a nozzle 270, hose or tube 268, or any other fluid coupling configured to couple the pressurized fluid source 264 to the inflatable membrane 380. As such, by supplying a pressurized fluid to the inflatable member 380, the inflatable member 280 may expand or inflate underneath deformable membrane 322, thereby deforming and/or moving the deformable membrane 322 to the actuated position. Similarly, by deflating the inflatable member 380, the deformable membrane 322 may be returned to the un-actuated position.

It should be appreciated that the inflatable member 380 may generally comprise any suitable object that may be inflated by a pressurized fluid. For example, in one embodiment, the inflatable member 380 may comprise an elongated balloon extending beneath the deformable membrane 322 along a portion of or the entire length 126 (FIG. 2) of the spoiler assembly 302. Additionally, it should be appreciated that the inflatable membrane 380 may generally be configured to define any suitable shape when inflated. For example, as shown in FIG. 8, the inflatable membrane 380 may define a circular cross-sectional shape. However, in alternative embodiments, the inflatable member 380 may define a rectangular, triangular or any other suitable cross-sectional shape when inflated.

Additionally, it should be appreciated that, when the disclosed rotor blade 100 includes more than one actuatable spoiler assembly 102, 202, 302, the assemblies 102, 202, 302 may be controlled individually or in groups. For example, it may be desirable to move only a portion of the deformable membranes 122, 222, 322 into the actuated position in order to precisely control the amount of lift generated by the blade 100. Similarly, it may be desirable to move the deformable membranes 122, 222, 322 to differing heights 152 (FIG. 4) depending upon on the spanwise or chordwise location of each of the assemblies 102, 202, 302. It should also be appreciated that any suitable means may be utilized to control the actuators 132 and/or the pressurized fluid sources 264 (e.g., through valves) of the assemblies 102, 202, 302. For example, in one embodiment, the actuators 132 and/or pressurized fluid sources 264 may be communicatively coupled to the turbine controller 20 of the wind turbine 10 (FIG. 1) or any other suitable control device (e.g. a computer and/or any other suitable processing equipment) configured to control the operation of the actuators 132 and/or pressurized fluid sources 264.

Additionally, in several embodiments of the present subject matter, the disclosed rotor blade 100 may include any suitable means for determining the operating conditions of the blade 100 and/or the wind turbine 10 (FIG. 1). Thus, in one embodiment, one or more sensors (not shown), such as load sensors, position sensors, speed sensors, strain sensors and the like, may be disposed at any suitable location along the rotor blade 100 (e.g., at or adjacent to the blade root 104 (FIG. 2)), with each sensor being configured to measure and/or determine one or more operating conditions of the rotor blade 100. For example, the sensors may be configured to measure the wind speed, the loading occurring at the blade root 104, the deformation of the blade root 104, the rotational speed of the rotor blade 100 and/or any other suitable operating conditions. The disclosed spoiler assemblies 102, 202, 302 may then be moved to the actuated position based upon the measured/determined operating conditions to optimize the performance of the rotor blade 100. For instance, the sensors may be communicatively coupled to the same controller and/or control device as the actuator(s) 132 such that each deformable membrane 122 may be moved to the actuated position automatically based on the output from the sensors. Thus, in one embodiment, if the output from the sensors indicates that the wind speeds, root loading and/or root deformation is/are significantly high, each deformable membrane 122, 22, 322 may be moved to the actuated position in order to separate the airflow from the rotor blade 100and reduce the loading and/or deformation on the blade root 104. However, it should be appreciated that, in alternative embodiments, the present subject matter need not be controlled based on output(s) from a sensor(s). For example, the deformable membranes 122, 222, 322 may be moved to the actuated position based on predetermined operating conditions and/or predetermined triggers programmed into the control logic of the turbine controller 20 or other suitable control device.

As an alternative to actively actuating the disclosed deformable membranes 122, 222, 322, it should be appreciated that the deformable membranes 122, 222, 322 may also be configured to be passively actuated. For instance, in several embodiments, the deformable membranes 122, 222, 322 may be passively actuated based on the pressure differential between the suction side of the rotor blade 100 and the interior of the blade. Specifically, the deformable membranes 122, 222, 322 may be adapted such that, at or above a particular pressure differential between the suction side and blade interior (e.g., due to wind speeds at or above a particular wind speed threshold), the forces created by pressure differential cause the deformable membrane to deform outwardly into the actuated position. Once the pressure differential is reduced (e.g., when the wind speed decreases below the wind speed threshold), the deformable membranes 122, 222, 322 may then return to the un-actuated position. It should be appreciated that such passive actuation of the deformable membranes 122, 222, 322 may also be combined with an active control feature. For instance, in one embodiment, a suitable locking mechanism (e.g., an actuatable mechanical lock or adjustable pressure seal) may be utilized to maintain the deformable membranes 122, 222, 322 in the un-actuated position. In such an embodiment, once the wind speeds and/or blade loading reaches a predetermined point (e.g., at a wind speed threshold), the locking mechanism may then be released to permit the deformable membrane to be forced outwardly due to the pressure differential between the suction side and the interior of the blade.

Moreover, it should be appreciated that the spoiler-like member formed by the deformable membrane 122, 222, 322 may generally have any suitable cross-sectional shape, such as a triangular, rectangular or arced cross-sectional shape. Additionally, in several embodiments, the shape defined by the spoiler-like member may be symmetrical or eccentric.

Further, it should be appreciated that present subject matter is also directed to a method for actuating a spoiler assembly 102, 202, 302 relative to an outer surface 124 of a wind turbine rotor blade 100. The method may generally include applying a force (e.g., using the actuator 132 or pressurized fluid) to a deformable membrane 122, 222, 322 disposed adjacent to the outer surface 124 in order to move at least a portion of the deformable membrane 122, 222, 322 from an un-actuated position to an actuated position and removing the force from the deformable membrane 122, 222, 322 in order to return the deformable membrane 122, 222, 322 to the actuated position.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade for a wind turbine, the rotor blade comprising:
a shell having a pressure side and a suction side, said shell defining an outer surface along said pressure and suction sides over which an airflow travels; and
a spoiler assembly including a deformable membrane disposed adjacent to said outer surface, said deformable membrane being configured to be deformed relative to said outer surface such that at least a portion of said deformable membrane is movable between an un-actuated position and an actuated position,
wherein said at least a portion of said deformable membrane is configured to separate the airflow from said outer surface when in said actuated position.

2. The rotor blade of claim 1, wherein said spoiler assembly further comprises an actuator disposed within said shell, said actuator being configured to move said at least a portion of said deformable membrane to said actuated position.

3. The rotor blade of claim 2, further comprising an actuating ram configured to be linearly actuated against said deformable membrane.

4. The rotor blade of claim 2, wherein said shell defines a slot through at least one of said suction side and said pressure side, said deformable membrane being secured to said shell so as to cover said slot.

5. The rotor blade of claim 4, further comprising an actuating ram configured to be linearly actuated through said slot in order to move said deformable membrane into said actuated position.

6. The rotor blade of claim 2, wherein said spoiler assembly further comprises a pressurized fluid source.

7. The rotor blade of claim 6, wherein said pressurized fluid source is in flow communication with a cavity defined between said deformable membrane and said shell.

8. The rotor blade of claim 7, wherein said pressurized fluid source is configured to supply pressurized fluid to said cavity in order to move said deformable membrane to said actuated position.

9. The rotor blade of claim 6, further comprising an inflatable member in flow communication with said pressurized fluid source, said inflatable member being disposed beneath between said deformable membrane and said shell.

10. The rotor blade of claim 8, wherein said pressurized fluid source is configured to supply pressurized fluid to said inflatable member in order to move said deformable membrane to said actuated position.

11. The rotor blade of claim 1, wherein said deformable membrane is formed at least partially from an elastic material.

12. The rotor blade of claim 1, wherein said deformable membrane is configured to be substantially aligned with said outer surface when said deformable membrane is in said un-actuated position such that a substantially continuous aerodynamic surface is defined between said deformable membrane and said outer surface.

13. The rotor blade of claim 1, wherein said deformable membrane defines a height above said outer surface when in said actuated position.

14. The rotor blade of claim 1, further comprising a plurality of spoiler assemblies spaced apart along said rotor blade.

15. A rotor blade for a wind turbine, the rotor blade comprising:
a shell having a pressure side and a suction side, said shell defining an outer surface along said pressure and suction sides over which an airflow travels; and, a spoiler assembly, the spoiler assembly including:
a deformable membrane disposed adjacent to said outer surface, said deformable membrane being configured to be deformed relative to said outer surface such that at least a portion of said deformable membrane is movable between an un-actuated position and an actuated position; and,
means for moving said at least a portion of said deformable membrane to said actuated position.

16. A method for actuating a spoiler assembly relative to an outer surface of a rotor blade of a wind turbine, the method comprising:
applying a force to a deformable membrane disposed adjacent to the outer surface in order to move at least a portion of said deformable membrane from an un-actuated position to an actuated position; and,
removing said force from said deformable membrane so as to return said at least a portion of said deformable membrane to said un-actuated position.

17. The method of claim 16, wherein applying a force to a deformable membrane disposed on the outer surface in order to move at least a portion of said deformable membrane from an un-actuated position to an actuated position comprises actuating an actuating ram against said at least a portion of said deformable membrane.

18. The method of claim 17, wherein a slot is defined through the outer surface and said deformable membrane is disposed over said slot, wherein actuating an actuating ram against said at least a portion of said deformable membrane comprises actuating said actuating ram within the rotor blade through said slot and against said at least a portion of said deformable membrane.

19. The method of claim 16, wherein applying a force to a deformable membrane disposed on the outer surface in order to move at least a portion of said deformable membrane from an un-actuated position to an actuated position comprises inflating said deformable membrane with a pressurized fluid.

20. The method of claim 16, wherein applying a force to a deformable membrane disposed on the outer surface in order to move at least a portion of said deformable membrane from an un-actuated position to an actuated position comprises inflating an inflatable member disposed beneath said deformable membrane with a pressurized fluid.
